(19) United States
(12) Patent Application Publication
(10) Pub. No.: US 2006/0209237 A1
(43) Pub. Date: Sep. 21, 2006

(54) Liquid crystal display device

(75) Inventors: Kunihiro Tashiro, Matsusaka-shi (JP); Yasutoshi Tasaka, Tokyo (JP); Hidefumi Yoshida, Kawasaki-shi (JP); Manabu Sawasaki, Kawasaki-shi (JP); Tomonori Tanose, Kawasaki-shi (JP)

Correspondence Address: GREER, BURNS & CRAIN, 300 S WACKER DR, 25TH FLOOR, CHICAGO, IL, 60606, US

(73) Assignee: SHARP KABUSHIKI KAISHA

(21) Appl. No.: 11/286,713

(22) Filed: Nov. 23, 2005

(30) Foreign Application Priority Data
Nov. 25, 2004 (JP) 2004-340815

(51) Int. Cl. G02F 1/1335

(52) U.S. Cl. 349/114

(57) ABSTRACT

A semi-transparent-type liquid crystal display device comprises a liquid crystal panel including a first substrate, a second substrate disposed behind the first substrate, and a liquid crystal layer confined between the first and second substrates, the liquid crystal panel being formed with picture element regions each having a filter of any of red, green and blue color, a backlight source disposed behind the liquid crystal panel, and a reflection member disposed further behind the backlight source, each of the plurality of picture element regions including therein a reflection region and a transmission region, wherein, in each of the picture element regions, the color filter is provided with an opening in correspondence to the reflection region, the opening provided in the filter of the green color having the largest area and having an area ratio of 50% or larger but equal to or smaller than 100% with respect to the reflection region.

### BACKGROUND OF THE INVENTION

The present invention generally relates to liquid crystal display devices and more particularly to a liquid crystal display device having the capability of both of reflection display function and transmission display function, such as the one used for portable terminals, or the like.

A so-called semi-transparent-type liquid crystal display device is a display device combining the feature of reflection display device and transmission display device and is capable of performing display under various environments, by performing the function of a reflection display device by utilizing environmental light when operated in a bright environment and performing the function of a transmission display device by utilizing the light from a backlight source when operated in a dark environment.

FIG. 1 schematically shows the construction of such a semi-transparent-type liquid crystal display device 10.

Referring to FIG. 1, the semi-transparent-type liquid crystal display device 10 includes a liquid crystal panel formed by sandwiching a liquid crystal layer 11 between a pair of substrates (not shown), and there are disposed consecutively a circularly polarized plate 12, a backlight source 13 and a reflection member 14 at the rear side of the liquid crystal panel. Further, there is provided another circularly polarized plate 15 on an outer surface of the liquid crystal panel at the front side, and a color filter layer 16 is formed to a rear side of the front side substrate.

Further, there is formed a reflection electrode 17 in the liquid crystal layer 11 in correspondence to a reflection region RX, while there is formed a transparent electrode (not shown) in a transmission region where there is formed no reflection electrode 17.

Thus, with the semi-transparent-type liquid crystal display device 10 of FIG. 1, there are formed a reflection region RX and a transmission region TX in each pixel region of each color, wherein it will be noted that, in the transmission region TX, the transmission light passes through the color filter layer 16 only once as shown with an arrow A, while in the reflection region RX, the reflected light passes through the color filter layer 16 twice, once at the time of incoming, and once at the time of outgoing, as shown in the drawing by an arrow B.

Thus, there arises a problem in that the reflection display tends to become dark when a color filter used with usual transmission liquid crystal display devices is used for the color filter layer 16 in such a semi-transparent-type liquid crystal display device 10.

Further, with the liquid crystal display device 10 of the construction in which the reflection member 14 is provided behind the backlight source 13, there is also formed a reflection light in the transmission region TX as shown with an arrow C, wherein the reflection light C thus formed also passes through the color filter layer 16 twice.

On the other hand, when a color filter designed for ordinary reflection type liquid crystal display device is used in such a semi-transparent-type liquid crystal display device, there arises a problem that the color reproducing range is narrowed in the transmission mode.

In order to solve this known problem, there have been proposals in the art of semi-transparent-type liquid crystal display device such as:

(1) use a color filter having a color characteristic intermediate of a color filter for reflection display mode and the color filter for transmission display mode;

(2) use a color filter for the transmission display mode and provide color compensation means to the reflection part, and the like.

With the proposal (1), in which-there is no need of providing specially designed color compensation means to any of the reflection region and transmission region, there is an advantage of simple construction for easy implementation, while this approach compromises the color characteristic to the middle of the reflection display mode and transmission display mode and there inevitably arises a problem in that the reflection display becomes dark and the color reproducing range is narrowed in the transmission display mode.

On the other hand, the construction of the approach (2) has an advantageous feature, although requiring a more complicated construction as compared with the construction of (1), that the color characteristic can be optimized to each of the reflection display mode and the transmission display mode. Because of this, the approach (2) is used commonly except for the applications to low-cost electron devices.

For example Japanese Laid-Open Patent Application 10-268289 official gazette (Patent Reference 1) discloses a reflection type liquid crystal display device capable of providing bright display by providing the color filter with a smaller area than the picture element area.

On the other hand, Japanese Laid-Open Patent Application 2000-111902 official gazette (Patent Reference 2) discloses the technology of providing, in a reflection region of a semi-transparent-type liquid crystal display device, a region where a color filter layer is formed and a region where such a color filter is not formed, for achieving the desired color compensation.

Furthermore, Japanese Laid-Open Patent Application 2000-267081 official gazette (Patent Reference 3) achieves color compensation by decreasing the color density of the color filter formed in the reflection region with respect to the color density of the color filter formed for the transmission region such that the spectral transmission (film thickness) of the color filter is increased (thickness decreased) in the reflection region.

Further, Japanese Laid-Open Patent Application 2002-311423 official gazette (Patent Reference 4) discloses a semi-transparent-type liquid crystal display device in which openings are formed to the color filters of the reflection region with sizes different according to the colors such that the color reproducing range in the transmission region coincides with the color reproducing range in the reflection region.

Further, Japanese Laid-Open Patent Application 2003-248216 (Patent Reference 5) discloses a reflection type liquid crystal display device having improved brightness and color reproducibility, by setting the light transmission rate of a red coloration layer, the light transmission rate of a green coloration layer and the light transmission rate of a blue coloration layer to fall in the range of 1.0-1.2:1.5-1.7:1.0.

### References

Patent Reference 1 Japanese Laid-Open Patent Application 10-268289 official gazette

Patent Reference 2 Japanese Laid-Open Patent Application 2000-111902 official gazette

Patent Reference 3 Japanese Laid-Open Patent Application 2000-267081 official gazette Patent Reference 4 Japanese Laid-Open Patent Application 2002-311423 official gazette

Patent Reference 5 Japanese Laid-Open Patent Application 2003-248216 official gazette

Patent Reference 6 Japanese Laid-Open Patent Application 2003-255324 official gazette

### SUMMARY OF THE INVENTION

Thus, in the art of conventional semi-transparent-type liquid crystal display device, there have been proposals of conducting color compensation for the reflection region by providing an opening to the color filter of the reflection region or decreasing the color filter film thickness of the reflection region, while it is noted, in the known art of Patent References 1-3 explained previously, that the openings are provided uniformly throughout the picture element regions of respective colors, or the film thickness of the color filter is decreased uniformly over the picture element regions of the respective colors.

Thus, with such a conventional construction, while the problem of brightness of the reflection display mode or the problem of color reproducing range at the time of the transmission display mode is solved to certain extent, it is not possible to provide a satisfactory solution to the problem of coloration of white display in the reflection display mode.

It should be noted that this coloration is caused as a result of wavelength dependence of the birefringence of the members that constitute the liquid crystal display device and because of the fact that the liquid crystal display device is designed to best reflect or transmit the light of a particular wavelength, such as the wavelength in the vicinity of 550 nm where the visual sensitivity becomes maximum.

Thus, with the liquid crystal display device optimized to a particular wavelength, the birefringence value is deviated from the optimum value except for the specific wavelength to which the optimization has been made, as a result of wavelength dependence of the birefringence of the respective components.

This difference appears large in the blue wavelength region located at the short wavelength side, and as a result, a white display tends to bear a yellowish coloration. In the case of transmission display, it may be possible to correct such coloration by changing the color tone of the backlight provided behind the display panel, while in the case of reflection display, it is not possible to change the color tone of the optical source, and the coloration is observed as it is.

Particularly, in the case of the semi-transparent-type liquid crystal display device shown in FIG. 1 in which the reflection member 14 is disposed behind the backlight source 13 for increasing the efficiency of utilization of light, the reflection light from the transmission region is also recognized as the reflection display, wherein the reflection light from the transmission region is affected with this problem of deviation of birefringence more heavily than the reflection light from the reflection region, and there can be a case in which the white display goes beyond the yellowish taste and becomes greenish, particularly in the so-called the micro reflection type liquid crystal display device in which the area ratio of the reflection region is larger than the area ratio of the transmission region or the reflection strength of the reflection region is smaller than the reflection strength of the transmission region.

Now, the prior art technology of Patent Reference 4 explained previously changes the size of the opening for each picture element region when conducting the color compensation of the reflection region.

With this prior art, however, the size of the opening is changed so as make the color reproducing range of the light transmitted through the transparent electrode to be coincident with the color reproducing range of the light reflected by the reflection electrode, and thus, it is not possible to sufficiently compensate for the displayed coloration, which includes the effect of the reflection light from transmission region, even when the size of the opening is changed within this range.

Further, with the prior art according to Patent Reference 5, color compensation is achieved for the reflection region by changing the ratio of light transmission rate for each picture element by changing the pigment concentration or the film thickness. However, because this technology only compensates for the displayed color with regard to the light reflected from the reflection electrode, the compensation of the displayed color by taking into consideration the effect of the reflection light in the transmission region becomes inevitably insufficient.

In a first aspect of the present invention, there is provided a semi-transparent-type liquid crystal display device, comprising:

a liquid crystal panel comprising a first substrate, a second substrate disposed behind said first substrate, and a liquid crystal layer confined between said first and second substrates, said liquid crystal panel being formed with picture element regions each having a filter of any of red, green and blue color;

a backlight source disposed behind said liquid crystal panel; and

a reflection member disposed further behind said backlight source,

each of said plurality of picture element regions including therein a reflection region and a transmission region,

wherein, in each of said picture element regions, said color filter is provided with an opening in correspondence to said reflection region, said opening provided in said filter of said green color having the largest area and having an area ratio of 50% or larger but equal to or smaller than 100% with respect to said reflection region.

In another aspect, the present invention provides a semi-transparent-type liquid crystal display device, comprising:

a liquid crystal panel comprising a first substrate, a second substrate disposed behind said first substrate, and a liquid crystal layer confined between said first and second substrates, said liquid crystal panel being formed with picture element regions each having a filter of any of red, green and blue color;

a backlight source disposed behind said liquid crystal panel; and

a reflection member disposed further behind said backlight source,

each of said plurality of picture element regions including therein a reflection region and a transmission region,

wherein, in each of said picture element regions, said color filter having a film thickness in said reflection region smaller than in said transmission region, said color filter of said green color having the minimum film thickness, said color filter of said green color having a film thickness ratio, defined as a ratio between a film thickness in said transmission region and a film thickness in said reflection region, of 0% or more but not exceeding 10%.

According to the present invention, it becomes possible, in a semi-transparent-type liquid crystal display device, comprising: a liquid crystal panel comprising a first substrate, a second substrate disposed behind the first substrate, and a liquid crystal layer confined between the first and second substrates, the liquid crystal panel being formed with picture element regions each having a filter of any of red, green and blue color; a backlight source disposed behind the liquid crystal panel; and a reflection member disposed further behind the backlight source, each of said plurality of picture element regions including therein a reflection region and a transmission region, to suppress coloration of white display in the reflection display mode, by providing, in each of the picture element regions, the color filter with an opening in correspondence to the reflection region, such that the opening provided in the filter of the green color has the largest area and has an area ratio of 50% or larger but equal to or smaller than 100% with respect to the reflection region, or by providing, in each of the picture element regions, the color filter to have a film thickness in the reflection region smaller than in the transmission region and such that the color filter of the green color has the minimum film thickness, the color filter of the green color having a film thickness ratio, defined as a ratio between a film thickness in the transmission region and a film thickness in the reflection region, of 0% or more but not exceeding 10%.

Other objects and further features of the present invention will become apparent from the following detailed description of the preferred embodiments of the present invention when read in conduction with the attached drawings.

### BRIEF DESCRIPTION OF THE DRAWINGS

FIG. 1 is a diagram showing a schematic construction of a semi-transparent-type liquid crystal display device;

FIG. 2 is a diagram explaining the principle of the present invention;

FIG. 3 is another diagram explaining the principle of the present invention;

FIG. 4 is another diagram explaining further principle of the present invention;

FIG. 5 is a diagram showing the construction of a semi-transparent-type liquid crystal display device according to a first embodiment of the present invention;

FIGS. 6A-6D are diagrams showing the construction of electrode and color filter in the semi-transparent-type liquid crystal display device of FIG. 5;

FIGS. 7 and 8 are diagrams showing a whiteness change caused by the reflection light from the reflection region of the semi-transparent-type liquid crystal display device of FIG. 5;

FIGS. 9 and 10 are diagrams showing a whiteness change caused by the reflection light from be the transmission region in the semi-transparent-type liquid crystal display device of FIG. 5;

FIG. 11 is a diagram showing a whiteness change of the entire reflection light for the semi-transparent-type liquid crystal display device of FIG. 5;

FIG. 12 is another diagram showing a whiteness change of the entire reflection light for the semi-transparent-type liquid crystal display device of FIG. 5 as a whole;

FIG. 13 is a diagram showing the construction of a picture element electrode used with the semi-transparent-type liquid crystal display device of FIG. 5;

FIG. 14 is a diagram showing the construction of a semi-transparent-type liquid crystal display device according to a second embodiment of the present invention;

FIG. 15 is a diagram showing a whiteness change of entire reflection light for the semi-transparent-type liquid crystal display device of FIG. 14 as a whole;

FIG. 16 is another diagram showing the whiteness change of the entire reflection light for the semi-transparent-type liquid crystal display device of FIG. 14.

### DETAILED EXPLANATION OF PREFERRED EMBODIMENTS [Principle]

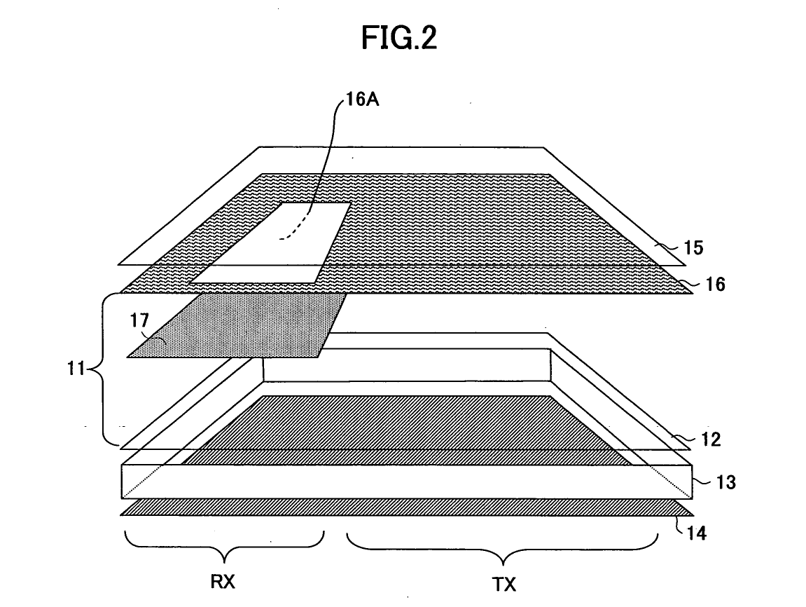

Hereinafter, the principle of the present invention will be explained with reference to FIGS. 2-4, wherein those parts corresponding to the parts explained previously are designated by the same reference numerals and the description thereof will be omitted.

FIG. 2 shows the fundamental construction of the present invention.

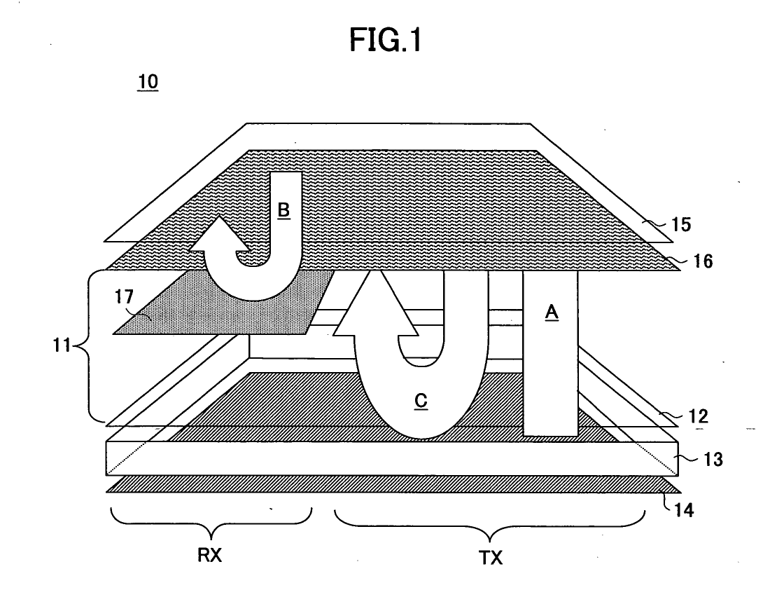

Referring to FIG. 2, there is provided an opening or thin-film part 16A (explained hereinafter as opening) in the color filter layer 16 in correspondence to the reflection electrode 17 with the present invention, wherein the present invention secures brightness in the reflection display mode by using the reflection light B and the reflection light C shown in FIG. 1 and expands the color reproducing range by optimizing the area of the opening 16A and suppresses the coloration of white display at the same time.

Thus, the opening 16A is provided in order to compensate for the color filter 16 provided for the transmission region, such that the reflection characteristic thereof comes closer to that of the color filter for the reflection region. Here, the brightness of the reflection display mode can be increased by increasing the area ratio of the opening 16A, while this at the same time result in narrowed color reproducing range.

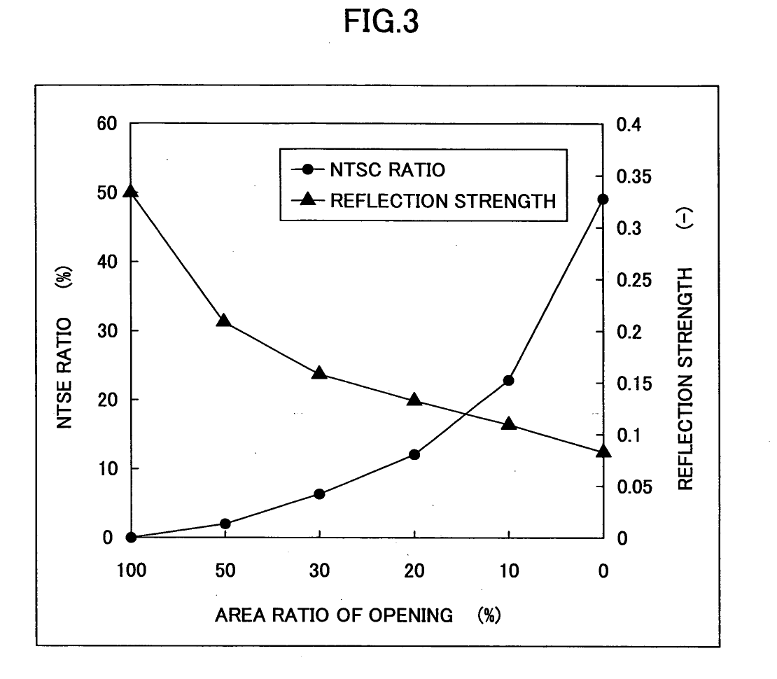

FIG. 3 shows the relationship between the area ratio of the opening 16A to the reflection electrode 17 and the color reproducing range and the relationship between the foregoing area ratio and the corresponding reflection strength in the semi-transparent-type liquid crystal display device 20 of FIG. 2, wherein it should be noted that FIG. 3 shows the foregoing relationship with regard to the reflection light B shown in FIG. 1 for the case in which the area ratio of the opening 16A is changed uniformly in each of the red, green and blue picture element regions. Here, it should be noted that the color reproducing range is represented in terms of NTSC ratio.

Referring to FIG. 3, it can be seen that the reflection strength increases with increasing area ratio of the opening 16A while there occurs a decrease of NTSC ratio with such increase of the area ratio.

On the other hand, when the effect of the reflection light C from the transmission region TX is taken into consideration, the NTSC ratio becomes larger than the one represented in the drawing. For example, in the case the area ratio of the picture elements between the reflection region RX and transmission region TX is about 2:7 and the reflection strength per unit area is identical between the reflection region RX and the transmission region TX, there occurs an increase of the NTSC ratio from 12% to 34% when the area ratio of the opening 16A is set to 20% of the reflection region RX.

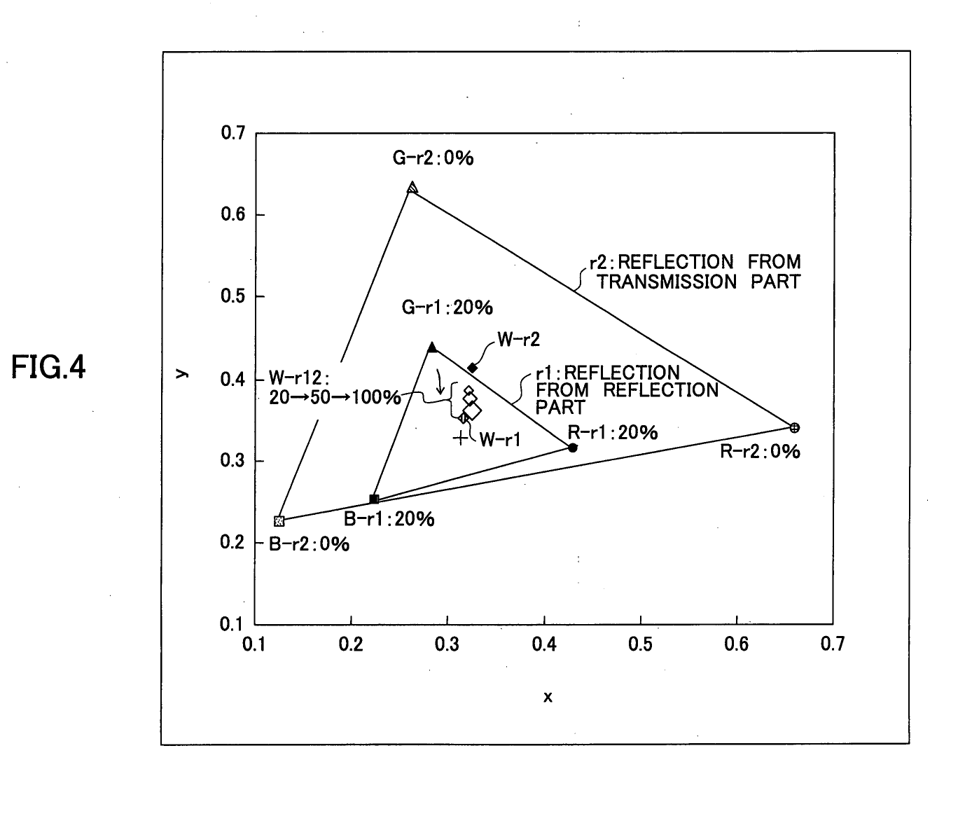

FIG. 4 represents the color reproducing range and white display with regard to reflection lights r1 and r2 in the construction of FIG. 2, wherein r1 represents the reflection light B from the reflection region RX while r2 represents the reflection light C from the transmission region TX. In FIG. 4, it should be noted that the area of the opening 16A is set to 20% of the reflection electrode 17 throughout the red, green and blue picture elements.

Referring to FIG. 4, the color reproducing range for the reflection light B from the reflection region RX is limited to a small region defined by points R-r1, G-r1 and B-r1 because of the existence of the opening 16A, while with regard to the reflection light C from the transmission region TX, there exists no such an opening. Further, because the reflection light C goes and backs through the color filter 16 twice similarly to the reflection light B, there is an expansion in the color reproducing range as represented by a large area defined by the points R-r2, G-r2 and also B-r2.

On the other hand, with regard to the reflection light B, it can be seen that the white display is located generally at the central part (coordinate W-r1) of the color reproducing range (R-r1, G-r1, B-r1) for the reflection light B defined by the points R-r1, G-r1 and B-r1, while with regard to the reflection light C, it can be seen that the color coordinate W-r2 of the white color is deviated away from the color reproducing range for the reflection light B in the direction of green.

Thus, with the semi-transparent-type liquid crystal display device 20 of FIG. 2, the effect of the reflection light B, and hence the effect of the reflection light r1 of FIG. 4, is superimposed with the effect of the reflection light C, and hence the effect the reflection light r2 of FIG. 4, at the time of the reflection display mode. With this, there occurs a shifting of whiteness of the white display in the direction of green color as a whole.

The present invention solves this problem by setting the area ratio of the opening 16A with respect to the reflection electrode to 50% or more in the green picture element.

According to the present invention, it becomes possible to compensate for the whiteness over an expanded range of (x, y)=(0.32±0.02, 0.36±0.02), which is defined by the sum of the reflection light r1 and reflection light r2.

In FIG. 4, small ⋄, middle ⋄ and large ⋄ respectively represents the change of actual display color of white for the case the area ratio of the opening 16A is set to 20%, 50% and 100% for the green picture element while maintaining the area ratio of the opening 16A to be 20% for the red picture element and blue picture element. As can se seen in FIG. 4, when it becomes possible to correct the whiteness of the white color to the degree that shown in FIG. 4 with intermediate ⋄, it becomes possible to realize the whiteness to be not very much different from the whiteness W-r1 for the color r1, and it becomes possible to compensate for the color of the reflection display, in which the reflection light C from the transmission region TX is added, to the degree similar to the ordinary reflection type liquid crystal display device, also in the semi-transparent type liquid crystal display device 20 of FIG. 2.

Further, it becomes possible with the present invention to obtain the same function and effect as above, by forming a thin-film part in the color filter 16 of FIG. 2 by reducing the filter film thickness in place of forming the opening 16A.

In the known technology of Patent Reference 4, in which the size of the opening is changed in each picture element such that the color reproducing range of the transmission light that transmits through the transparent electrode coincides with the color reproducing range of the reflection light reflected by the reflection electrode, it should be noted that the area ratio of the opening is much smaller than the area ratio of the present invention in any of the example therein.

Further, with the known technology of Patent Reference 5, the transmittance is changed in each picture element so as to compensate for the color of the reflection light reflected by the reflection electrode. Thereby, the Y transmittance for the green color filter layer is set to 1.5-1.7 times the transmittance of the red and blue color filter layers.

Contrary to this, the present invention optimizes the film thickness of the color filter such that the film thickness (transmittance) of the green color filter is larger than the film thickness of the red or blue color filter layer by twice to infinite (zero film thickness).

### First Embodiment

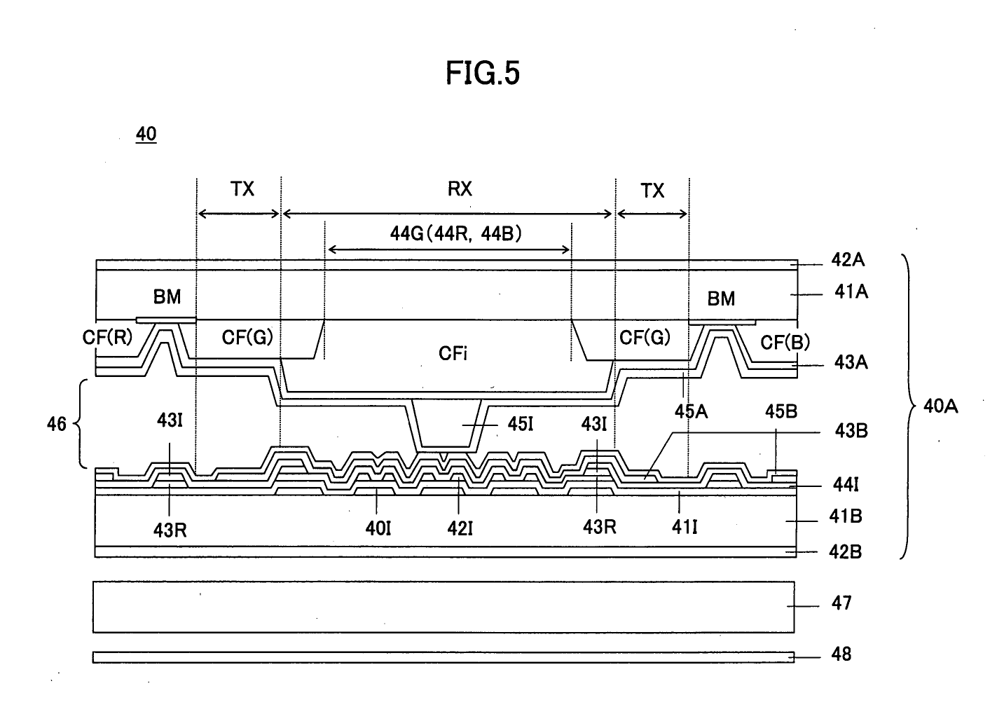

FIG. 5 shows the cross-sectional construction of a semi-transparent-type liquid crystal display device 40 according to a first embodiment of the present invention for one picture element region corresponding to a particular color (R, G, B).

Referring to FIG. 5, there are formed two transmission region TX and one reflection region RX in the liquid crystal display device 40, wherein the liquid crystal display device 40 has a pair of glass substrates 41A and 41B that oppose with each other, and a circularly polarizing plate 42A us provided on an outside surface of the glass substrate 41A. Further, another circularly polarizing plate 42B is formed on an outside surface of the glass substrate 41B.

Further, there are formed color filters CF of any of red (R), green (G) and blue (B) on an inner side of the glass substrate 41A, and openings 44R, 44G and 44B to be explained later are formed in correspondence to the reflection region RX. Further, a transparent resin CFi is formed on the opening.

Further, a transparent opposing electrode 43A of ITO (indium tin oxide: In₂O₃SnO₂), and the like, is formed on the color filter CF and the resin film CFi uniformly.

On the other hand, on the inner side of the glass substrate 41B, there is formed a transparent picture element electrode 43B such as ITO, and the transparent picture element electrode 43B is driven by a TFT (not shown) formed on the glass substrate 41B.

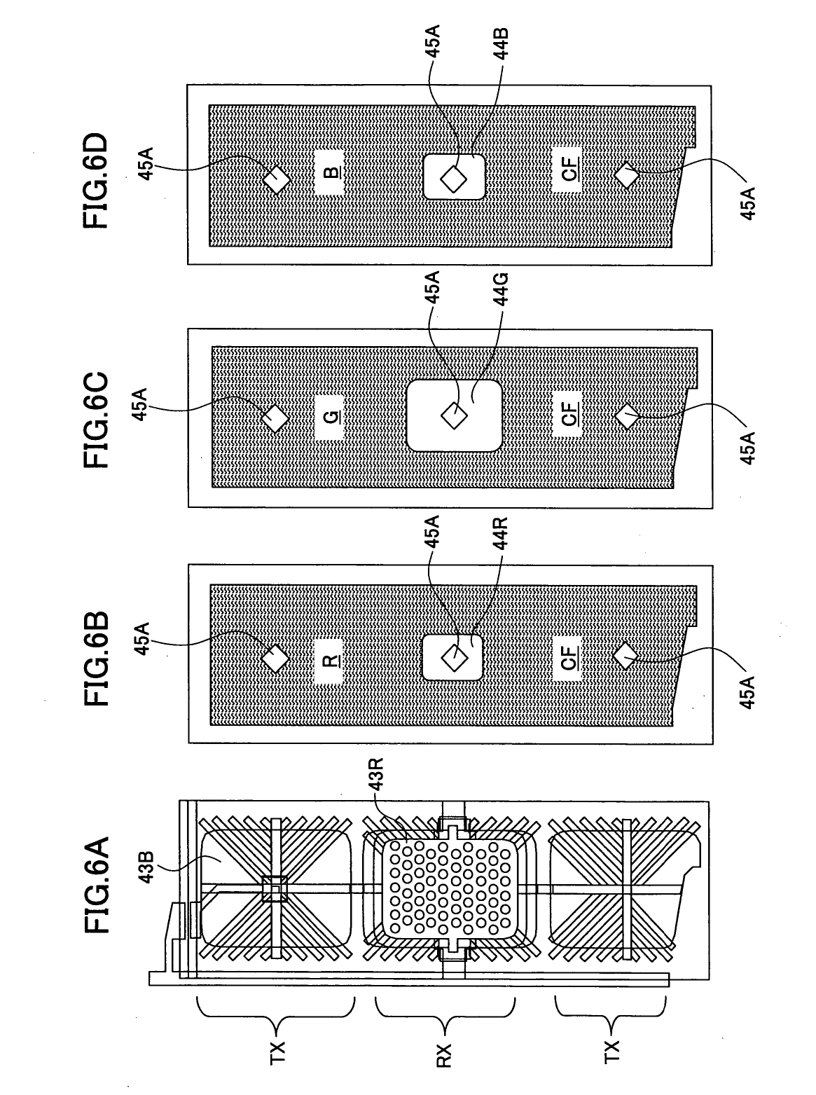

Further, there is formed a reflection electrode 43R in correspondence to the reflection region RX shown in the plan view of FIG. 6 via a gate metal 40I, a gate insulation film 41I and a channel protective film 42I, and the metal reflection electrode 43R is connected electrically to the pixel electrode 43B via a contact hole not represented.

Incidentally, the gate metal 40I, the gate insulation film 41I and the channel protective film 42I are formed with an uneven pattern for causing reflection of the reflection light by the reflection electrode 43R uniformly in all directions.

Further, there is formed an alignment control structure 45I on the substrate 41A, wherein the alignment control structure 45I is formed on the opposing electrode 43 by a resist pattern and controls the alignment of the liquid crystal molecules. The exposed surface of the alignment control structure 45I and the exposed surface of the opposing electrode 43A are covered by a vertical alignment film 45A.

Similarly, the exposed surface of the transparent picture element electrode 43B and the exposed surface of the final insulation film 44I on the glass substrate 41B are covered by a vertical alignment film 45B. Further, a liquid crystal layer 46 containing liquid crystal molecules of negative dielectric anisotropy, for example, is confined between the substrates 41A and 41B.

Thereby, the vertical alignment films 45A, 45B cause alignment of the liquid crystal molecules in the liquid crystal layer 46 in the direction generally perpendicularly to the surface of the substrates 41A and 41B in a non-activated state in which no driving voltage is applied across the transparent pixel electrode 43B and the transparent opposing electrode 43A.

In such a vertical alignment liquid crystal display device, the liquid crystal molecules in the liquid crystal layer 46 changes the alignment direction thereof generally parallel to the surface of the substrates 43A and 43B in a drive state in which a drive voltage is applied across the transparent opposing electrode 43A and the transparent picture element electrode 43B.

Further, the alignment control structure 45I collaborates with minute slit patterns formed in the transparent picture element electrode 43B and controls the direction in which the liquid crystal molecules are tilted in the driving state, and thus realizes so-called domain structure and achieves improvement of response speed of the liquid crystal display device at the same time.

Further, with the semi-transparent-type liquid crystal display device 40 of FIG. 5, there is disposed a backlight source 47 behind the liquid crystal panel 40A including therein the liquid crystal layer 46 confined between the glass substrates 41A and 41B. Furthermore, a reflection sheet 48 is disposed further behind the backlight source 47.

FIG. 6A shows the patterns of the transparent picture element electrode 43B and the reflection electrode 43R formed on the glass substrate 41B.

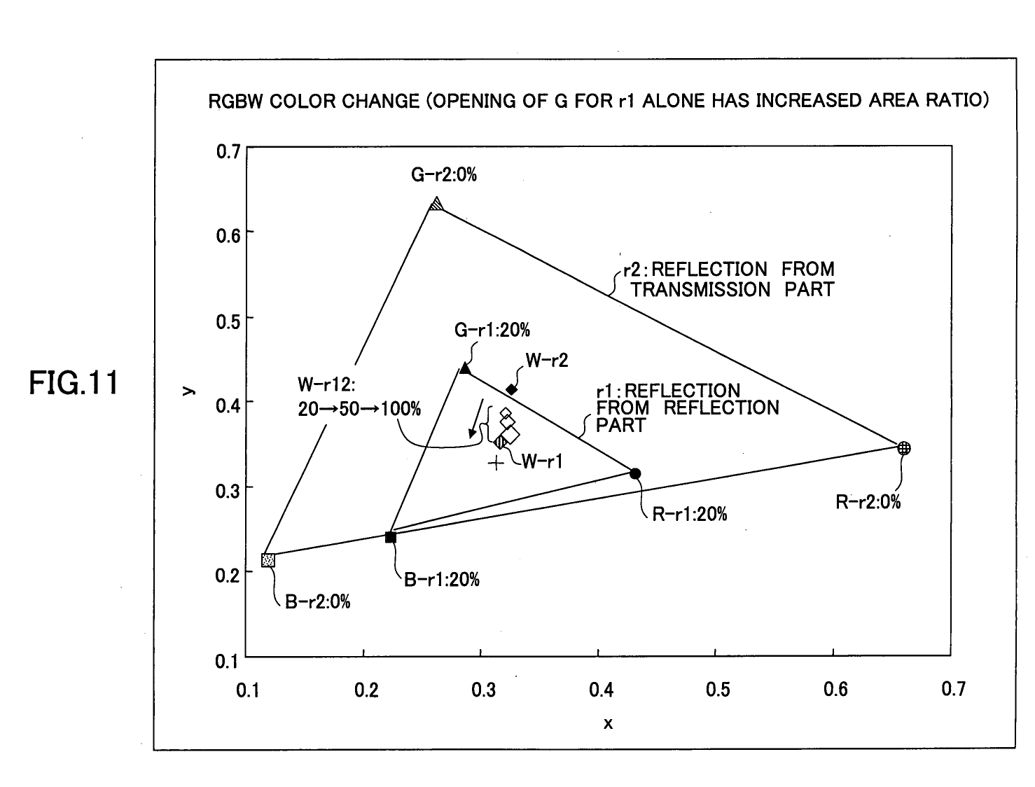

Referring to FIG. 6A, the transparent picture element electrode 43B consists of a transparent conductive film such as an ITO film wherein it will be noted that there are formed numerous minute slit patterns in each of the transmission region TX and the reflection region RX such that the minute slit patterns are formed symmetrically with regard to the alignment control structure 45I (reference should be made to FIG. 11 to be explained later).

Thus, when a drive voltage is applied to the transparent pixel electrode 43B, the minute slit patterns function to modify the drive electric field, and as a result, tilting of the liquid crystal molecules in the extending direction of each minute slit pattern is facilitated. Thus, in each of the transmission regions TX and the reflection region RX, there are formed plural domains characterized by respective, different tilting directions for the liquid crystal molecules by the alignment control structure 45I and the minute slit patterns in the transparent picture element electrode 43B.

It should be noted that the transparent picture element electrode 43B and the reflection electrode 43R of FIG. 6A constitute the picture element region of red, green or blue on the glass substrate 41B.

FIGS. 6B-6D show the construction of color filter CF formed on the glass substrate 41A respectively in correspondence to the picture element regions of red (R), green (G) and blue (B).

Referring to FIGS. 6B-6D, there is formed an opening 44R in the color filter CF(R) for the red color (R) in correspondence to the reflection region 43R, while the color filter CF(G) for the green color (G) is formed with an opening 44G in corresponding to the reflection region 43R. Further, the color filter CF(B) for the blue color (B) is formed with an opening 44B in correspondence to the reflection region 43R.

In the plan view of FIGS. 6B-6D, it should be noted that the openings 44R-44B are formed such that the alignment control structures 45I are located generally at the center of the corresponding openings.

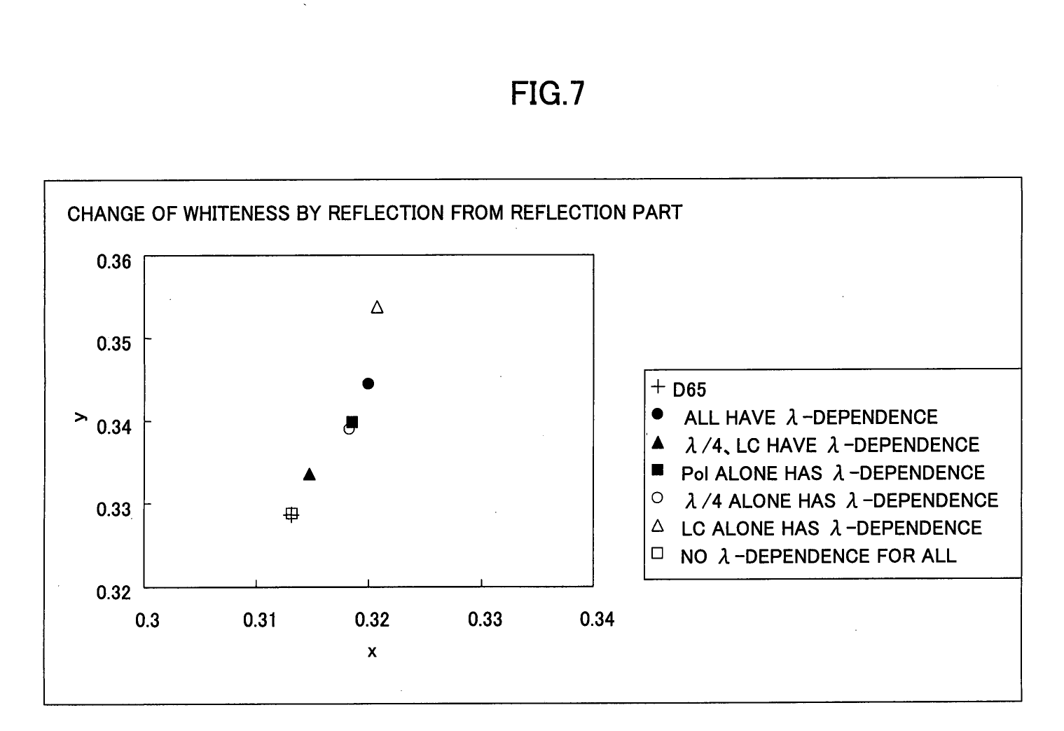

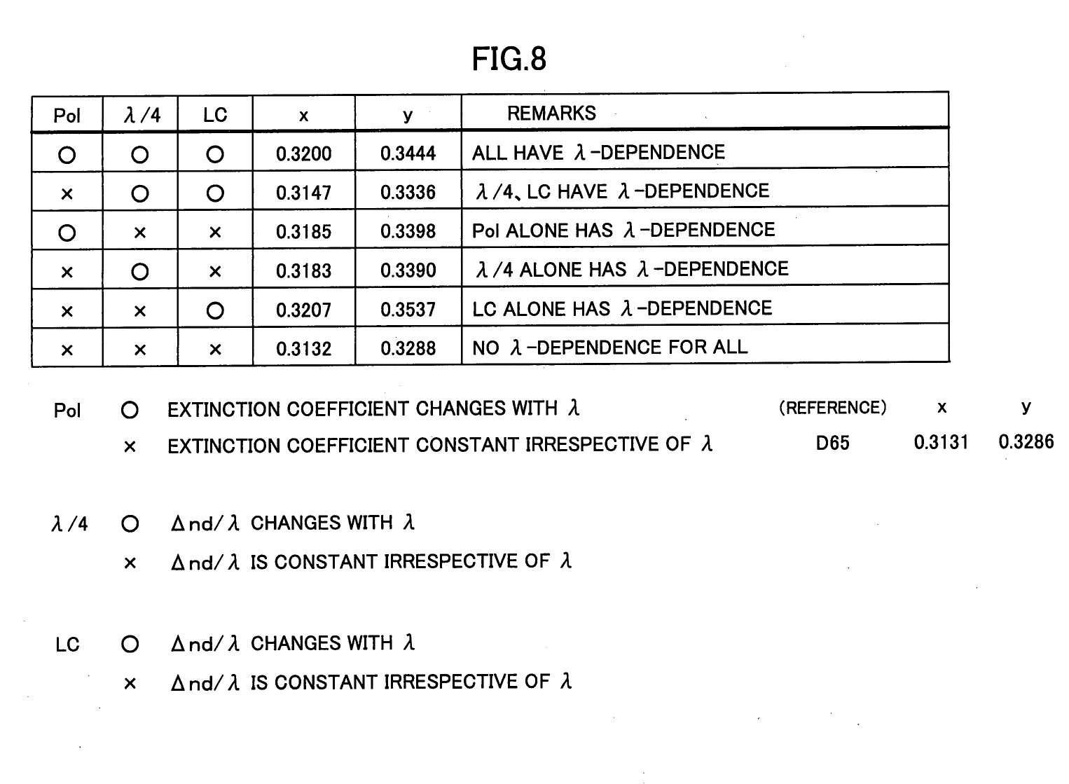

FIGS. 7 and 8 show the whiteness change of the white display caused in the semi-transparent-type liquid crystal display device 40 of FIG. 5 by the reflection light from the reflection region RX, and thus, the coloration of the white display caused by the reflection light from the reflection electrode 43R (insertion reflection plate). In the illustrated example, each of the circularly polarizing plates 42A and 42B is formed of a combination of a liner polarizing plate (Pol) and a λ/4 phase plate wherein the circularly polarizing plates 42A and 42B are disposed such that the absorption axes of the respective linear polarizing plates intersect perpendicularly with each other and such that the retardation axes of the respective λ/4 phase plates intersect perpendicularly with each other.

With such a construction, the reflection light obtained in the reflection region RX travels through various optical components along the path of: the linear polarizing plate (Pol) constituting the circularly polarizing plate 42A→the λ/4 phase plate forming the circularly polarizing plate 42A→the liquid crystal layer 46 the reflection electrode 43R→the liquid crystal layer 46→the λ/4 phase plate constituting the circularly polarizing plate 42A→the linear polarizing plate (Pol) constituting the circularly polarizing plate 42A. Here, FIGS. 7 and 8 show the result of calculation of coloration (whiteness) change of the white display caused by absence and presence of wavelength dependence in the above-noted optical members. Further, “+” in FIG. 7 represents the whiteness of a D65 standard optical source.

Referring to FIG. 7, it can be seen that a whiteness comparable to that of the D65 standard optical source is obtained in the case there is no wavelength dependence in the birefringence in any of these optical members, while there occurs a significant deviation of whiteness in the case there exists a wavelength dependence in the birefringence in these members.

Thus, when the whiteness for the case in which there exists a wavelength dependence is compared with the whiteness for the case in which there exists no wavelength dependence in FIGS. 7 and 8, it can be seen that the contribution of the wavelength dependence of the various optical members to the whiteness change changes the magnitude thereof with the order of: liquid crystal layer>linear polarizing plate≈λ/4 phase plate, for the reflection light from the reflection region RX provided with the reflection electrode 43R.

Here it should be noted that the wavelength dependence of the liquid crystal layer and the wavelength dependence of the λ/4 phase difference plate are in a compensating relationship, and thus, the whiteness change caused by superposition of these effects is smaller than the whiteness change caused by the individual members.

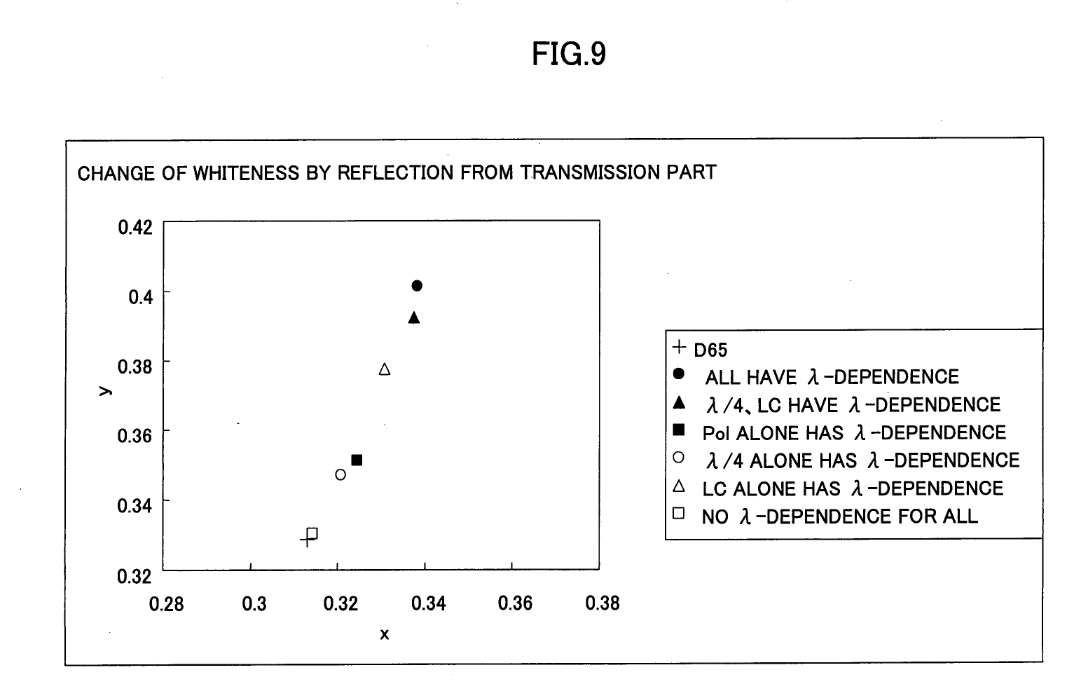

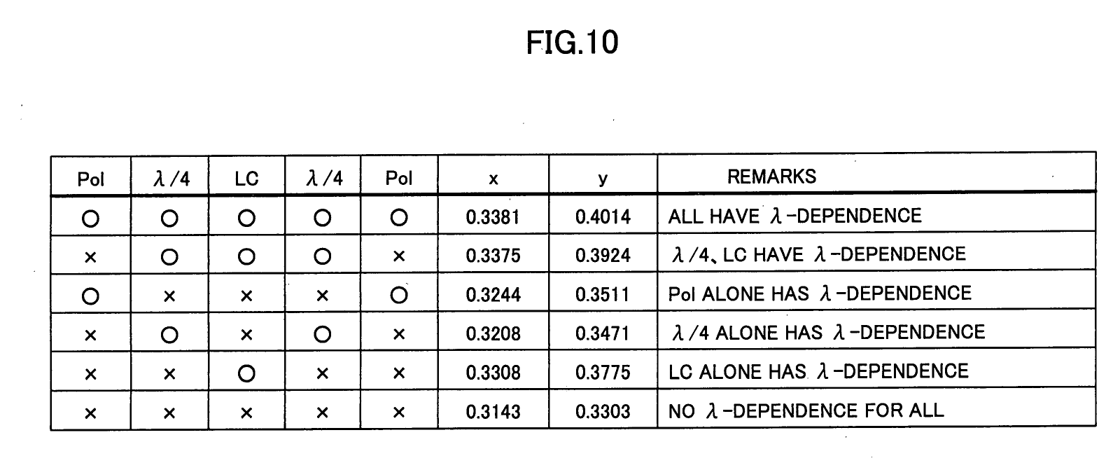

FIGS. 9 and 10 show the whiteness change caused by the reflection light from the transmission region TX, and hence the reflection light from the reflection sheet 48 (external reflection plate). In FIGS. 9 and FIG. 10, it should be noted that the panel construction is the same as the one shown in FIG. 5. Thus, the reflection light from the transmission region TX travels through various optical components in the order of: linear polarizing plate (Pol) constituting the circularly polarizing plate 42A→λ/4 phase plate constituting the circularly polarizing plate 42A→liquid crystal layer 46→λ/4 phase plate constituting the circularly polarizing plate 42B→linear polarizing plate (Pol) constituting the circularly polarizing plate 42B→reflection sheet 48 (external reflection plate)→linear polarizing plate (Pol) constituting the circularly polarizing plate 42B→λ/4 phase plate constituting the circularly polarizing plate 42B→liquid crystal layer 46→λ/4 phase plate constituting the circularly polarizing plate 42A→linear polarizing plate (Pol) constituting the circularly polarizing plate 42A.

In FIGS. 9 and 10, too, the whiteness change caused by presence or absence of wavelength dependence in each optical member is calculated and represented similarly to FIGS. 7 and 8.

Referring to FIGS. 9 and 10, it can be seen, from the comparison between the whiteness change for the case there is a wavelength dependence in the foregoing optical members and the whiteness change for the case there is no such wavelength dependence, that the contribution of the wavelength dependence of the optical members upon the whiteness change is represented in the order of: liquid crystal layer 46>linear polarizing plate Pol≈λ/4 phase plate, for the reflection light from the transmission region where the reflection sheet 48 is provided. Here, it should be noted that the wavelength dependence of the liquid crystal layer and the wavelength dependence of the λ/4 phase plate are not in the mutually compensating relationship, and thus, the whiteness change caused by superposition of these becomes larger as compared with the whiteness change of the individual members.

The reason that the whiteness change and hence coloration of the while display become large in the case of the reflection light from the region where the reflection sheet 48 like is provided is believed to be caused by the cancellation of the wavelength dependence of the λ/4 phase plate as a result of the perpendicularly crossing arrangement of the circularly polarizing plate 42A and the circularly polarizing plate 42B, leading to the situation in which the wavelength dependence of the liquid crystal layer 46 appears directly in the reflection display.

From the foregoing, it will be understood that, with the semi-transparent-type liquid crystal display device 40 of the construction shown in FIG. 5 in which the reflection sheet 48 is provided to the backlight source 47 and reflection light is caused also in the transmission region TX, there occurs a considerable deviation of the whiteness of in reflection display to the green side due to the wavelength dependence of the panel construction.

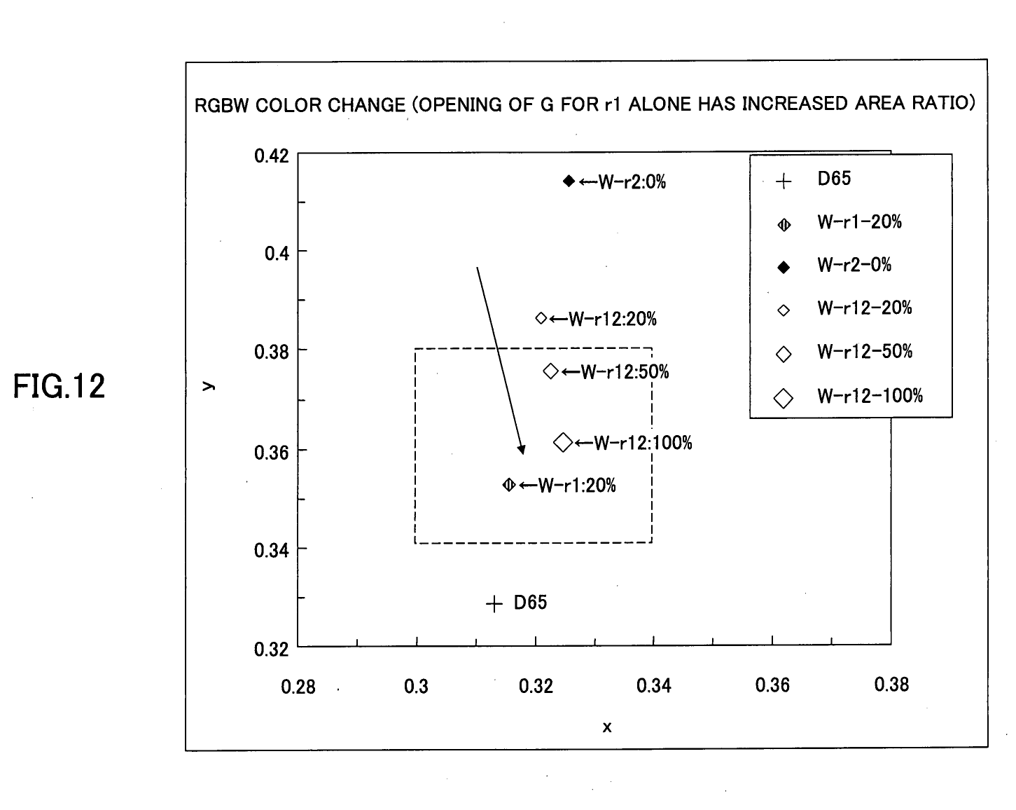

FIGS. 11 and 12 show the chromacity change taking place in the case the area ratio of the opening formed to color filter CF in the reflection region RX is changed only for the color filter of the green color (G).

Referring to FIGS. 11 and 12, the panel construction and the picture element construction of the liquid crystal display device are identical to those explained with reference to FIG. 5 and FIGS. 6A-6D, wherein each region of the transparent picture element electrode 43B on the TFT substrate 61B is divided generally equally into three parts, and a transmission region TX, a reflection region RX and a transmission region TX are respectively thereon.

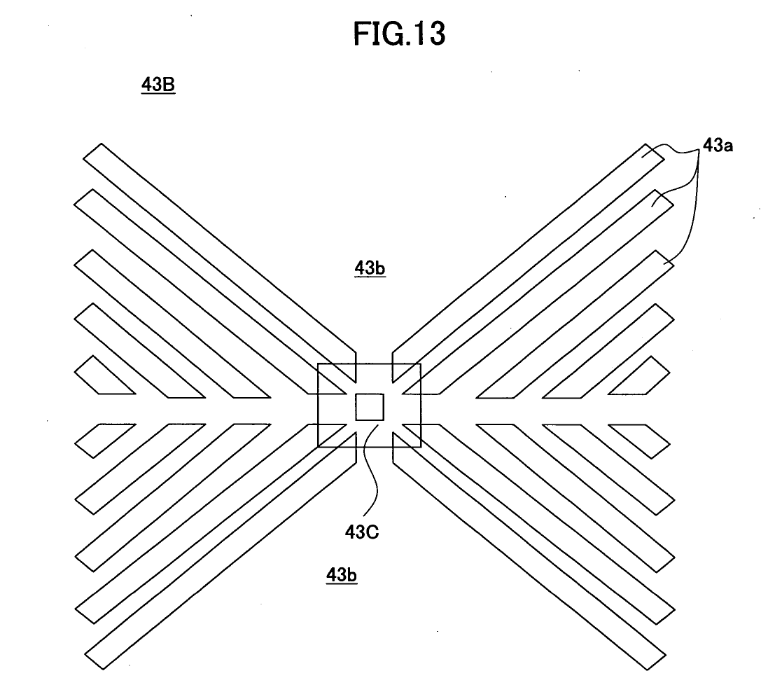

Further, the transparent picture element electrode 43B comprises the continuation region 43b and the minute slit patterns 43a formed to a part of the continuation region 43b as shown in the enlarged view of FIG. 13, wherein the transparent picture element electrode 43B is connected to the drain region of the TFT formed on the glass substrate 41B via a contact hole 43C in the transmission region TX and to the transparent picture element electrode 43B via a barrier metal 43I formed in a peripheral part of the reflection electrode 43R in the reflection region RX.

Further, the reflection electrode 43R is formed with a number of dot-form unevenness with dense alignment in correspondence to the gate layer or SA layer constituting the TFT element formed underneath.

On the glass substrate 41A, on the other hand, the color filter CF is formed by a transmission color filter (product of JSR Corporation) with the thickness of 1.3 μm, wherein there are formed the opening 44R, 44B in the color filters of the red color (R) and the color filter of the blue color (B) at a location corresponding to the reflection electrode 43R with area ratio of 20% with respect to the reflection electrode 43R.

On the other hand, the color filter of the green color (G) is provided with the opening 44G at the location corresponding to the reflection electrode 43R with the area ratio of 20%, 50% and 100% with respect to the area of the reflection electrode 43R.

Further, the transparent resin CFi is formed to the foregoing openings and the transparent pixel electrode 43A and the alignment control structure 45I are formed consecutively.

With the present embodiment, the vertical alignment films (product of JSR Corporation) 43A and 43B are applied upon the glass substrates 41B (TFT substrate) and the glass substrate 41A (CF substrate) thus prepared by a coating process, and the glass substrates 41A and 41B are combined with each other via a seal member not illustrated. Further, a liquid crystal having the negative dielectric anisotropy is injected to fill the gap between the substrates 41A and 41B, and with this, the liquid crystal display panel 40A is produced.

Furthermore, a pair of circularly polarizing plates each formed a linear polarizing plate and λ/4 phase plate (product of Sumitomo Chemical Co. Ltd.), are bonded at both sides of the liquid crystal display panel 40A. Further, a backlight unit (product of Fujitsu Kasei Limited) including therein condensing sheet, diffusion sheet, and the like, in addition to the backlight source 47 and the reflection sheet, is provided at the backside of the liquid crystal panel 40A, and with this, the semi-transparent-type liquid crystal display device 40 is completed.

Further, with regard to the semi-transparent-type liquid crystal display device 40 thus formed, the displayed chromacity of red, green and blue was measured by irradiating a parallel light from a D65 standard optical source.

FIG. 11 shows the chromacity coordinate in the case of displaying the red color (R), green color (G), blue color (B) and the white color (W) by the reflection light r1 obtained in the reflection region RX for the case the reflection sheet 48 is not provided behind the backlight source 47 are being shown.

Further, FIG. 11 also shows'similar color coordinates with regard to the reflection light r2 observed in the transmission region TX in the case the reflection sheet 48 is disposed behind the backlight source 47 and the reflection electrode 43R is shaded by providing a black matrix (BM) pattern to the side of the CF substrate 41A.

Furthermore, FIG. 11 shows similar chromacity coordinates with regard to the reflection light r12 observed in the reflection region RX and in the transmission region TX for the case in which the reflection sheet 48 is disposed behind the backlight source 47 and the reflection electrode 43R is not shaded.

In FIG. 11, it should be noted that the area ratio of reflection region RX to the transmission region TX is set to approximately 2:7 in each of the picture elements and that the reflection efficiency per unit area becomes almost 0.5 in the transmission region TX with regard the reflection region RX in which the reflection is defined to be 1.

Thus, the reflection strength represented with area conversion takes the value of 2×1=2 in the reflection region RX and 7×0.5=3.5 in the transmission region TX, and thus, it should be noted that the reflection strength in the reflection region RX is decreased with regard to the reflection strength in the transmission region TX.

Further, it should be noted that the designation such as “W-r12: 20→50→100%” in FIG. 11 or “r12-20%, r12-50%, r12-100%” in FIG. 12 represents the whiteness change of the reflection light r12 in which the reflection light r2 in the transmission region TX and the reflection light r1 in the reflection region RX are added, for the case the area ratio for the opening 44G alone is changed as 20→50→100% in the color filter of the Green color (G), while fixing the area ratio of the opening 44R in the color filter of the red color (R) and the opening 44B in the color filter of the blue color (B) to 20%.

Further, FIG. 12 is a diagram showing a part of FIG. 11 in detail.

Referring to FIGS. 11 and 12, it can be seen that the whiteness of the reflection light r12 shifts in the direction of the D65 optical source side and hence to the colorless side when the area ratio of the opening 44G in the color filter of the green color (G) alone is increased. Particularly, it becomes possible to shift the whiteness of the reflection light r12 up to the chromacity range (x, y)=(0.32±0.02, 0.36±0.02) as shown in FIG. 12 by a broken line, by setting the area ratio of the opening 44G to 50% or more.

It should be noted that the chromacity range surrounded by the broken line as noted above represents the limit of allowable variation of chromacity defined on the basis of the whiteness of the reflection light r1. When the whiteness fluctuates beyond this chromacity range, there occurs green coloration in the white display, and the reflection display bears coloration, which goes beyond the coloration of the reflection type liquid crystal display device.

While the above embodiment corresponds to the case in which the area of the reflection region RX is smaller than the area of transmission region TX and the reflection strength of the reflection region RX is smaller than the reflection strength of the transmission region TX, the present embodiment is applicable also to the case in which the area of the reflection region RX is larger than the area of the transmission region TX, as long as the reflection strength of the reflection region RX is smaller than the reflection strength of transmission region TX.

Here, it should be noted that the whiteness of the reflection light r12 experiences shifting with the reflection strength ratio of the reflection region RX to the transmission region TX, wherein the whiteness of the total reflection light r12 moves outside the aforementioned chromacity range to the side of green when the reflection strength r1 in the reflection region RX is smaller than reflection strength r2 in the transmission region TX.

From such circumstances it is thought that the present invention works most effectively when applied to a half transmission type (micro reflection type) liquid crystal display device.

In conclusion, it is possible with the present invention to compensate for the whiteness of the reflection display in a semi-transparent-type liquid crystal display device having a reflection member on the rear side of the backlight source, such that the whiteness falls in the chromacity range comparable to that of a reflection type liquid crystal display device, by setting the area ratio of the opening of the color filter with regard to the reflection region to be 50% or more but 100% or less for the green color filter.

### Second Embodiment

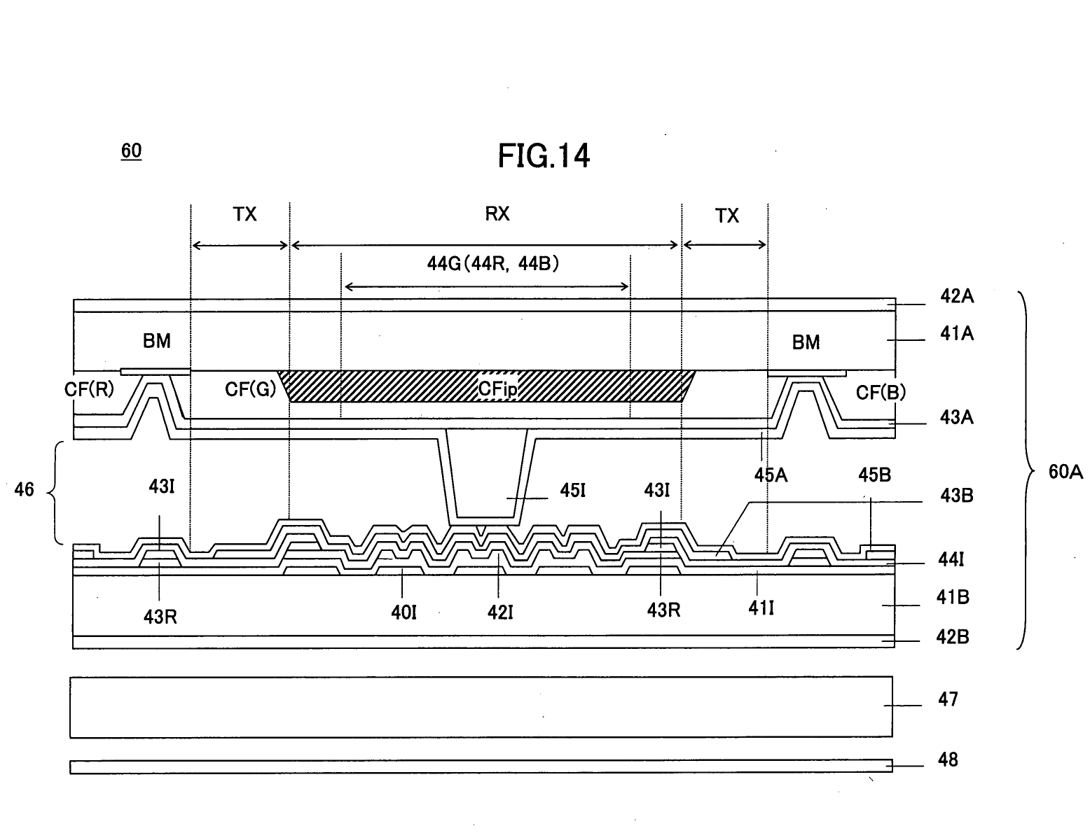

FIG. 14 shows the construction of a semi-transparent-type liquid crystal display device 60 according to a second embodiment of the present invention, wherein those parts of FIG. 14 corresponding to those parts explained previously are designated with the same reference numerals and the description thereof will be omitted.

Referring to FIG. 14, the film thickness of the color filter CF is reduced selectively with the present embodiment in the reflection region RX of the color filter CF of each color.

Thereby, the function and effect identical to the function and effect of providing the opening 44G in the previous embodiment are obtained by decreasing the filter film thickness in the reflection region RX of the color filter CF(G) for the green color (G) with regard to the corresponding filter film thickness of the color filter CF(R) for the red (R) color and the color filter CF(B) for the blue (B) color.

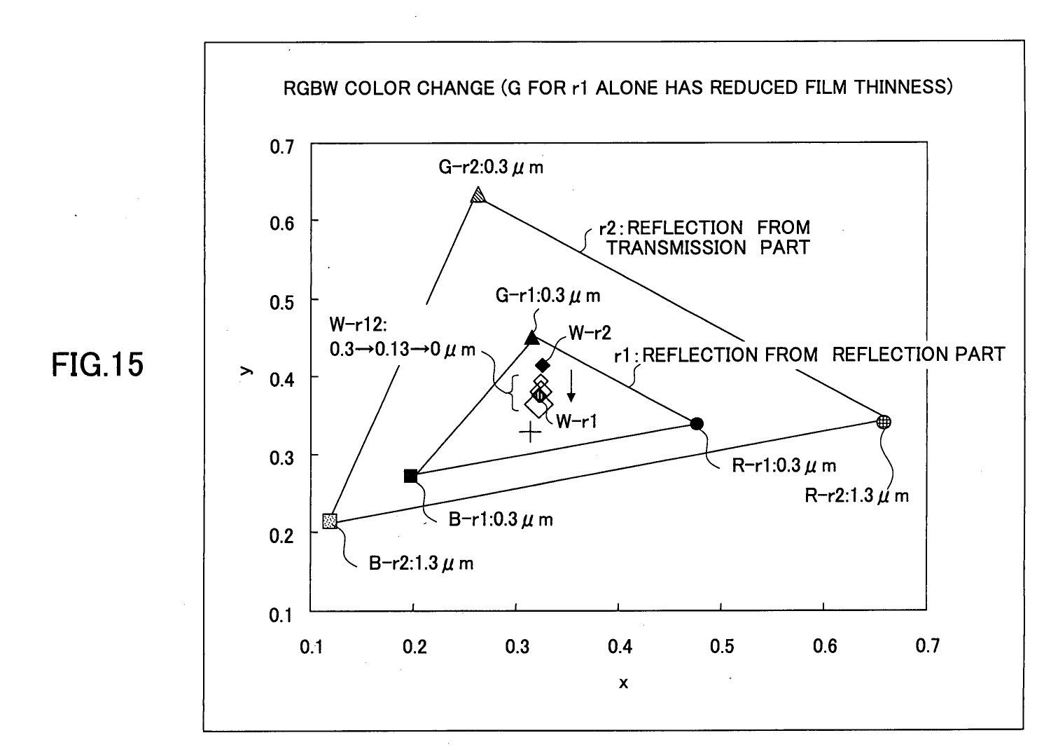

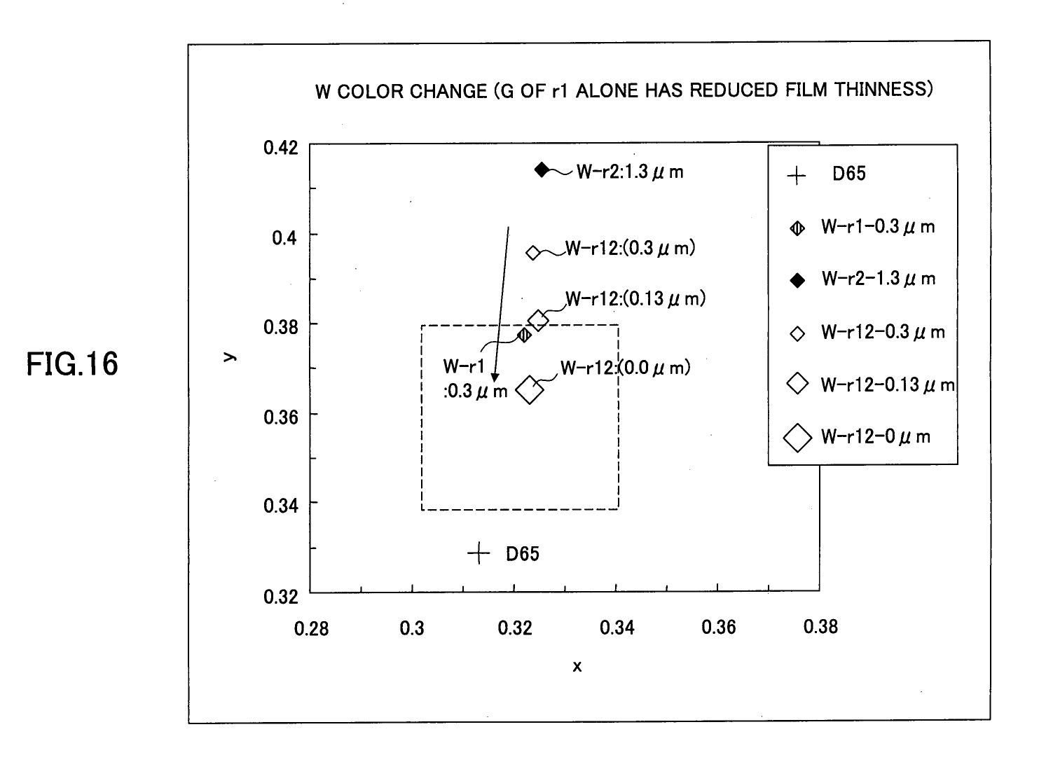

FIGS. 15 and 16 show the whiteness change for the case the film thickness of the color filter CF(G) for the green color (G) is reduced selectively in the reflection region RX in the semi-transparent-type liquid crystal display device 60 of FIG. 14.

Here, it should be noted that panel construction and also picture element construction are the same as those explained with the previous embodiment except for the color filter CF, and there are formed dense dot-form projections and depressions under the reflection electrode 43R by utilizing the gate electrode layer the and SA layer that constitute the TFT element.

Further, there is formed a color filter CF (product of JSR Corporation) on the glass substrate 41A with the thickness of 1.3 μm for the transmission display mode, wherein the thickness of the color filter CF is reduced to 0.3 μm in the reflection region RX for any of the filter CF for the red color (R) and the blue color (B) (in terms of the film thickness ratio, 23% of the filter film thickness of the transmission region TX). Further, with the green color filter for the green color (G) provided in the reflection region RX, the film thickness is changed to 0.3 μm, 0.13 μm and 0 μm (in terms of the film thickness ratio, respectively 23%, 10% and 0% of the filter film thickness of the transmission region TX).

In the embodiment of FIG. 14, the film thickness of the color filters CF(R), CF(G) and CF(B) in the reflection region RX is adjusted by forming a transparent resin pattern CFip underneath the color filter, and the transparent picture element electrode 43A and the alignment control structure 45I are formed on the color filter CF.

Further, the vertical alignment films 43A and 43B (product of JSR Corporation) are formed respectively on the glass substrates 41A and 41B so as to cover the transparent picture element electrodes 43A and the alignment control structure 45I and the transparent picture element electrode 43B and the reflection electrode 43R.

Further, the glass substrates 41A and 41B, are assembled each other via a seal and the liquid crystal display panel 60A is produced by injecting a liquid crystal having the negative dielectric anisotropy in to the gap formed therebetween.

Further, the circularly polarizing plates 42A and 42B (product of Sumitomo Chemical Co. Ltd) each including a linear polarizing plate and λ/4 phase plate are bonded at the respective outer sides of liquid crystal display panel 60A thus formed. Further, by disposing the backlight unit including the backlight source 47 and the reflection sheet 48 (product of Fujitsu Kasai Limited) behind the rear side of the circularly polarizing plate 42B, and hence at the opposite side thereof, the semi-transparent-type liquid crystal display device 60 is obtained.

Here, it should be noted that the backlight unit further includes a condensing sheet and a diffusion sheet.

Further, RGBW chromacity was measured with the semi-transparent-type liquid crystal display device 60 thus formed by irradiating parallel light from a D65 optical source.

FIG. 16 corresponds to FIG. 4 or FIG. 11 explained previously and designates the reflection lights from the red (R), green (G) and also blue (B) picture elements of the reflection region RX in the liquid crystal display device 60 of FIG. 14, in other words the reflection lights for the case in which the reflection sheet 28 is not provided, as R-r1, G-r1 and also B-r1 respectively. Further, FIG. 16 designates the reflection lights from the red (R), green (G) and blue (B) picture elements of the transmission region TX as R-r2, G-r2 and B-r2, respectively. Further, W-r1 represents the whiteness of the reflection light solely from the reflection region RX, while W-r2 represents the whiteness of the reflection light solely from the transmission region TX.

Further, W-r12 represents the whiteness of the reflection light from the reflection region RX and the transmission region TX.

Here, it should be noted that the area ratio between the reflection region RX and the transmission region TX is about 2:7 for each picture element, and the reflection efficiency per unit area is almost 0.5 for the reflection from the transmission region TX, provided that the reflection from the reflection region RX is defined to be 1.

Accordingly, the reflection strength represented in terms of the area conversion becomes 2×1=2 in the transmission region TX and 7×0.5=3.5 in the reflection region RX. Thereby, the reflection strength of the reflection region RX is small than the reflection strength of the transmission region TX.

In FIG. 16, it should be noted that the color filters CF(R) and CF (B) for the red color (R) and the blue color (B) are formed with the thickness of 0.3 μm in the reflection region RX, while the thickness of the color filter CF(G) for the green color (B) is changed to 0.3 μm, 0.13 μm and 0 μm in the reflection region RX (23%, 10% and 0% in terms of the film thickness ratio).

In the case that the film thickness of the color filter is Chum, there is formed no color filter CF is in the reflection region RX.

Referring to FIG. 16, it can be seen that the whiteness of reflection light r12, in other words, the whiteness of the reflection light including the reflection light from the reflection region RX and the reflection light from the transmission region TX undergoes shifting toward the direction of the D65 standard optical source designated by “+”, in other words, toward the colorless direction, by changing the film thickness of the color filter for the green color (G) to 0.3 μm, 0.13 μm and 0 μm in the reflection region RX. Particularly, by setting the film thickness of the filter to be 0.13 μm or less, (10% or less in terms of the film thickness ratio), it is possible to change the whiteness to fall in the chromacity range of (0.32±40.02, 0.36±0.02) shown in FIG. 16 with the broken line.

It should be noted that the foregoing chromacity range represents the range where the chromacity fluctuation is allowed based on the whiteness of the reflection light r1. When the white display moves outside the chromacity range, the white display bears greenish color and the reflection display experiences coloring exceeding the coloring in the case of a reflection type liquid crystal display device.

Thus, according to the present embodiment, it becomes possible with a semi-transparent-type liquid crystal display device 60 having a reflection member such as the reflection sheet 48 behind the backlight to compensate for the whiteness of the reflection display to the chromacity range comparable to an ordinary reflection type liquid crystal display device, by setting the film thickness ratio of the green (G) color filter formed in the reflection region RX to 0% or more but not exceeding 10% of the thickness of the color filter formed in the transmission region TX.

While the present invention have been explained heretofore with regard to the semi-transparent-type liquid crystal display device of vertical alignment (VA) mode, the present invention is not limited to such a vertical alignment mode liquid crystal display devices but is applicable also to semi-transparent-type liquid crystal display devices of horizontal alignment mode such as TN mode or STN mode.

While the present invention has been explained heretofore for preferred embodiments, the present invention is not limited to such particular embodiments and various variations and modifications may be possible within the scope of the invention set forth in the claims.

The present application is based on Japanese priority application No. 2004-340815 filed on Nov. 25, 2004, the entire contents of which are hereby incorporated by reference.

What is claimed is:

1. A semi-transparent-type liquid crystal display device, comprising:
a liquid crystal panel comprising a first substrate, a second substrate disposed behind said first substrate, and a liquid crystal layer confined between said first and second substrates, said liquid crystal panel being formed with picture element regions each having a filter of any of red, green and blue color;
a backlight source disposed behind said liquid crystal panel; and
a reflection member disposed further behind said backlight source,
each of said plurality of picture element regions including therein a reflection region and a transmission region,
wherein, in each of said picture element regions, said color filter is provided with an opening in correspondence to said reflection region, said opening provided in said filter of said green color having the largest area and having an area ratio of 50% or larger but equal to or smaller than 100% with respect to said reflection region.

2. The semi-transparent-type liquid crystal display device as claimed in claim 1, wherein a reflection strength from said reflection region is smaller than a reflection strength from said transmission region.

3. The semi-transparent-type liquid crystal display device as claimed in claim 1, wherein said reflection region has an area smaller than an area of said transmission region.

4. The semi-transparent-type liquid crystal display device as claimed in claim 1, wherein a reflection light formed by said reflection region and said reflection member has a whiteness falling in a range of (X, y)=(0.32±0.02, 0.36±0.02) under a D65 optical source.

5. The semi-transparent-type liquid crystal display device as claimed in claim 1, wherein said semi-transparent-type liquid crystal display device is a vertical-alignment mode liquid crystal display device.

6. The semi-transparent-type liquid crystal display device as claimed in claim 1, wherein said first substrate carries thereon a structure controlling alignment direction of liquid crystal molecules in said reflection region, said structure being formed generally at a center of said opening.

7. A semi-transparent-type liquid crystal display device, comprising:
a liquid crystal panel comprising a first substrate, a second substrate disposed behind said first substrate, and a liquid crystal layer confined between said first and second substrates, said liquid crystal panel being formed with picture element regions each having a filter of any of red, green and blue color;
a backlight source disposed behind said liquid crystal panel; and
a reflection member disposed further behind said backlight source,
each of said plurality of picture element regions including therein a reflection region and a transmission region,
wherein, in each of said picture element regions, said color filter having a film thickness in said reflection region smaller than in said transmission region, said color filter of said green color having the minimum film thickness, said color filter of said green color having a film thickness ratio, defined as a ratio between a film thickness in said transmission region and a film thickness in said reflection region, of 0% or more but not exceeding 10%.

8. The semi-transparent-type liquid crystal display device as claimed in claim 7, wherein a reflection strength from said reflection region is smaller than a reflection strength from said transmission region.

9. The semi-transparent-type liquid crystal display device as claimed in claim 7, wherein said reflection region has an area smaller than an area of said transmission region.

10. The semi-transparent-type liquid crystal display device as claimed in claim 7, wherein a reflection light formed by said reflection region and said reflection member has a whiteness falling in a range of (X, y)=(0.32±0.02, 0.36±0.02) under a D65 optical source.

11. The semi-transparent-type liquid crystal display device as claimed in claim 7, wherein said semi-transparent-type liquid crystal display device is a vertical-alignment mode liquid crystal display device.

12. The semi-transparent-type liquid crystal display device as claimed in claim 7, wherein said first substrate carries thereon a structure controlling alignment direction of liquid crystal molecules in said reflection region, said structure being formed generally at a center of said opening.
